(19) United States
(12) Patent Application Publication
(10) Pub. No.: US 2019/0034779 A1
(43) Pub. Date: Jan. 31, 2019

(54) Digital Learning Smart Identification Card Structure

(71) Applicant: Cannex Technology Inc., Changhua (TW)

(72) Inventor: Akira Yang, Changhua (TW)

(21) Appl. No.: 15/662,486

(22) Filed: Jul. 28, 2017

(51) Int. Cl. G06K 19/077

(52) U.S. Cl. CPC G06K 19/07749

(57) ABSTRACT

A smart identification card structure includes an identification card having a first face provided with an IPS (indoor presence system) and a second face provided with an IRS (interactive response system). Thus, the IPS and the IRS are integrated to construct the identification card, thereby enhancing the convenience and versatility of the smart identification card structure.

### BACKGROUND OF THE INVENTION

### 1. Field of the Invention

The present invention relates to an identification card and, more particularly, to a smart identification card structure.

### 2. Description of the Related Art

There are crowded with many people in some place, such as the campus, factories, communities and the like, so that the security management in such a specified place cannot depend only on the securities and the surveillance monitors. In the campus, a traditional identification card only contains the photo, name and title of the wearer. Recently, the current electronic identification card is popular. A “wisdom campus” consists of six systems including intelligent health care, intelligent administration, intelligent management, intelligent community, intelligent green energy and intelligent learning. The “wisdom campus” means to promote and integrate a variety of hardware and software services, so as to produce valuable intellectual applications. In the future, the “wisdom campus” should be added with the key elements of “network, sharing and self-making”, to develop a model network/sharing network, so as to achieve the spirit of the internet for multi-resource sharing, and to expand the existing experience, so that more teachers and students can participate in the experience of campus wisdom services, thereby forming a feedback mechanism to improve the services at the two terminals of the supply and the demand. Thus, the campus will be linked to the community and the urban development, to share the source of knowledge, so that the “wisdom campus” will share the intelligence, apply the intelligence and generate a new intelligence, and will promote the development of intelligent industry.

### BRIEF SUMMARY OF THE INVENTION

The primary objective of the present invention is to provide a smart identification card structure with a digital learning function.

In accordance with the present invention, there is provided a smart identification card structure comprising an identification card having a first face provided with an IPS (indoor presence system) and a second face provided with an IRS (interactive response system). The identification card is provided with a GPIO input module, a GPIO output module, and a communication module. The IPS includes a gateway, a server, a cloud, a LAN (local area network) computer and a smart mobile device. The communication module of the identification card actively transmits a signal of an information which is detected automatically by a wireless network receiver of the gateway which is connected by the WiFi or a network line to the server which transmits the signal to the cloud which has a database which stores, operates, manages, reports and aggregates the information. The database of the cloud picks up the information to perform a big data analysis which is sent to the LAN computer and the smart mobile device. The IRS includes a USB dongle, a PC (personal computer), the cloud, the LAN computer and the smart mobile device. The IRS is provided with a plurality of buttons which input serial numbers to download a software of the IRS from the cloud through the USB dongle and the PC.

According to the primary advantage of the present invention, the IPS and the IRS are integrated to construct the identification card, thereby enhancing the convenience and versatility of the smart identification card structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of the front face of an identification card in accordance with the preferred embodiment of the present invention.

FIG. 2 is a perspective view of the rear face of the identification card in accordance with the preferred embodiment of the present invention.

FIG. 3 is a plane view of a USB dongle and the front and rear faces of the identification card in accordance with the preferred embodiment of the present invention.

FIG. 4 is a perspective view of the identification card, the USB dongle and the gateway in accordance with the preferred embodiment of the present invention.

FIG. 5 is a schematic operational view of the smart identification card structure in accordance with the preferred embodiment of the present invention.

FIG. 6 is a block diagram of the smart identification card structure in accordance with the preferred embodiment of the present invention.

FIG. 7 is a plane usage view of the front and rear faces of the identification card in accordance with the preferred embodiment of the present invention.

FIG. 8 is a flow chart of the IPS of the smart identification card structure in accordance with the preferred embodiment of the present invention.

FIG. 9 is a systematic block diagram of the IPS of the smart identification card structure in accordance with the preferred embodiment of the present invention.

FIG. 10 is a flow chart of the IRS of the smart identification card structure in accordance with the preferred embodiment of the present invention.

FIG. 11 is a systematic block diagram of the IRS of the smart identification card structure in accordance with the preferred embodiment of the present invention.

### DETAILED DESCRIPTION OF THE INVENTION

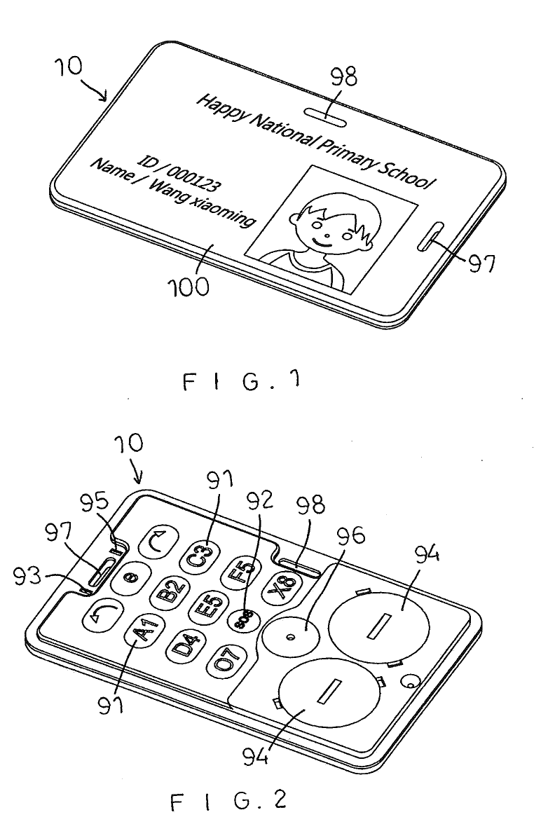

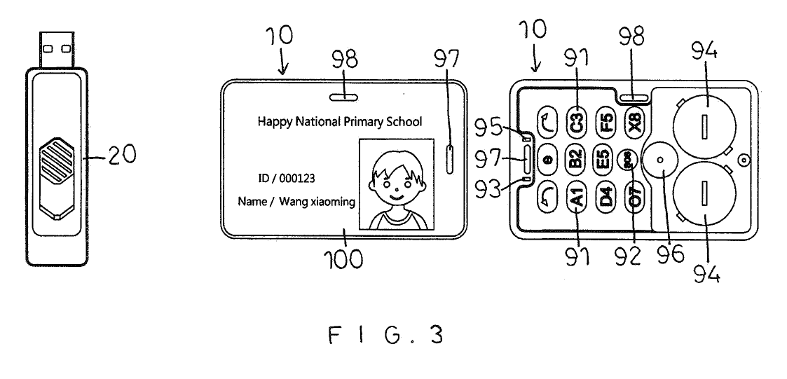

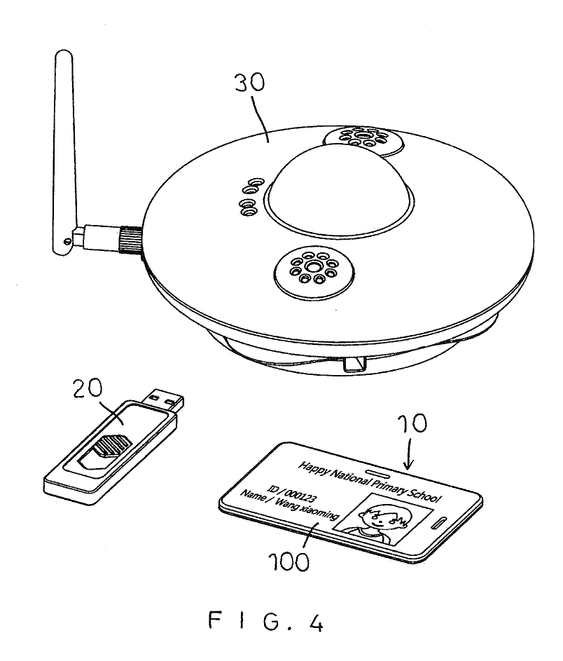

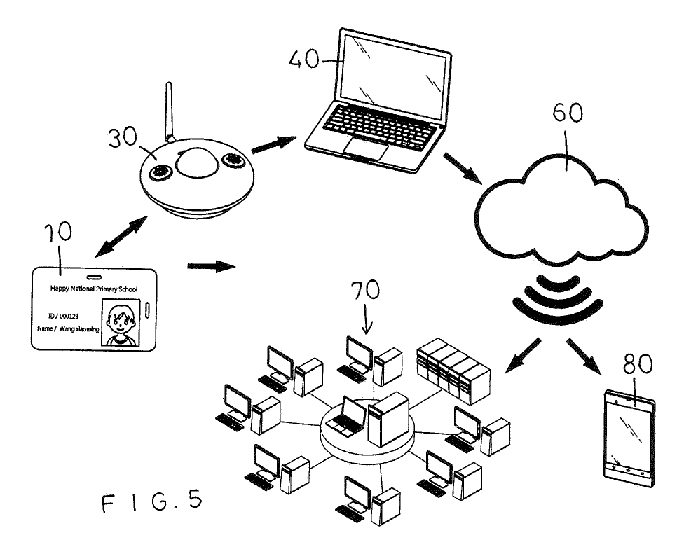

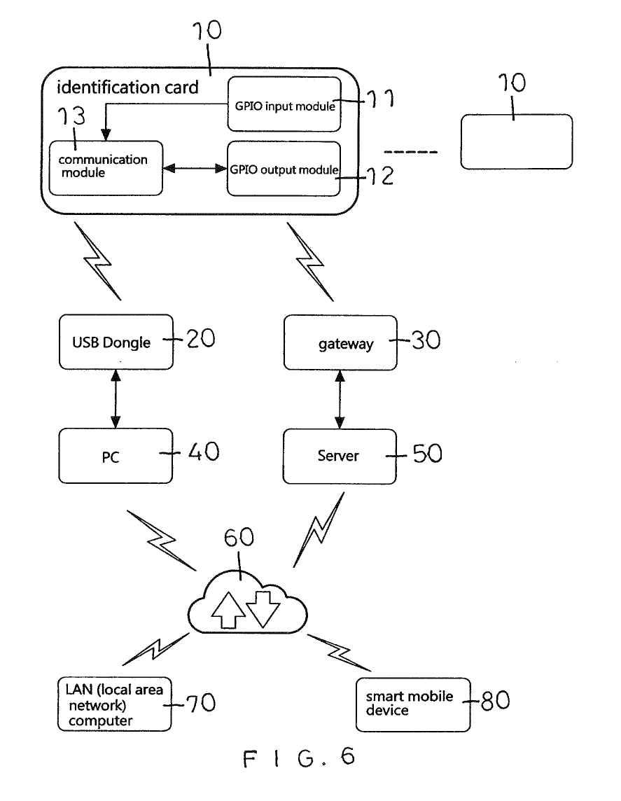

Referring to the drawings and initially to FIGS. 1-6, a smart identification card structure in accordance with the preferred embodiment of the present invention comprises an identification card 10 having a first face provided with an IPS (indoor presence system) and a second face provided with an IRS (interactive response system).

The identification card 10 is provided with a GPIO input module 11, a GPIO output module 12, and a communication module 13.

The IPS includes a gateway 30, a server 50, a cloud 60, a LAN (local area network) computer 70 and a smart mobile device 80. The communication module 13 of the identification card 10 actively transmits a signal of an information which is detected automatically by a wireless network receiver of the gateway 30 which is connected by the WiFi or a network line to the server 50 which transmits the signal to the cloud 60 which has a database which stores, operates, manages, reports and aggregates the information. The database of the cloud 60 picks up the information to perform a big data analysis which is sent to the LAN computer 70 and the smart mobile device 80. Preferably, the LAN computer 70 belongs to various management stratums of the school, and the smart mobile device 80 belongs to the teachers or the parents.

The IRS includes a USB dongle 20, a PC (personal computer) 40, the cloud 60, the LAN computer 70 and the smart mobile device 80. Preferably, the USB dongle 20 is externally inserted into a hardware device, such as a PC, a tablet computer or a notebook computer. The IRS is provided with a plurality of buttons 91 which input serial numbers to download a software of the IRS from the cloud 60 through the USB dongle 20 and the PC 40. Thus, the teacher can use the software of the IRS conveniently.

The cloud 60 can also send the editorial teaching materials, ask questions, test the students, or perform other interactive teaching, to immediately control grasp the learning situation of the students. In addition, the teachers can also store a variety of information in the cloud 60, and integrate a curriculum management system, such as the moodle (Modular Object-Oriented Dynamic Learning Environment) curriculum management system, which is an open source and a free e-learning software platform, for building the teaching materials and test questions, and for managing the learning results of the students. The software of the IRS can also be placed in Windows App, for functional charging by levels. In addition, the identification card 10 can monitor attendance of the students, and integrate the leisure card, the Line Point and other bonus point feedback platform, to increase the incentives for encouraging students to learn so as to reduce the financial burden of the students and for encouraging the students to attend the class.

In the preferred embodiment of the present invention, the communication module 13 of the identification card 10 is detected automatically to the cloud 60 by a bluetooth or RF or RFID (radio frequency identification) or NFC (near field communication).

In the preferred embodiment of the present invention, the first face of the identification card 10 is provided with a SIC (student identity card) 100 which contains a basic information of a student, including the photograph, name, class, ID (identification) number or the like.

In the preferred embodiment of the present invention, the second face of the identification card 10 is provided with an SOS button 92.

In the preferred embodiment of the present invention, the second face of the identification card 10 is provided with a wireless communication indication light 93. Preferably, the wireless communication indication light 93 has a green color.

In the preferred embodiment of the present invention, the second face of the identification card 10 is provided with a battery 94 and a low voltage warning light 95. Preferably, the low voltage warning light 95 has a red color.

In the preferred embodiment of the present invention, the second face of the identification card 10 is provided with a vibration detector which detects the identification card 10 and notifies the user when the identification card 10 is motionless to a preset time.

In the preferred embodiment of the present invention, the second face of the identification card 10 is provided with a buzzer 96.

In the preferred embodiment of the present invention, the identification card 10 is provided with a stored value facility.

In the preferred embodiment of the present invention, the identification card 10 uses the App of a cell phone.

In the preferred embodiment of the present invention, the smart mobile device 80 is a smart cell phone.

In the preferred embodiment of the present invention, the identification card 10 is provided with an upright hanging hole 97 and a transverse hanging hole 98.

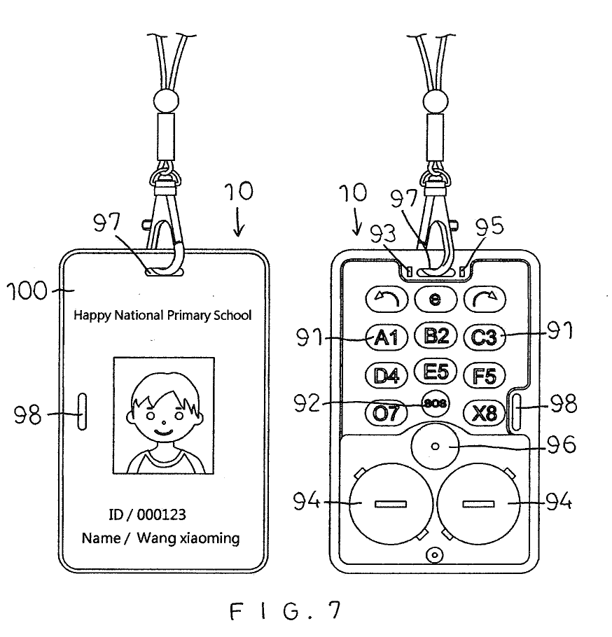

As shown in FIG. 7, the identification card 10 is attached to a hanger by the upright hanging hole 97.

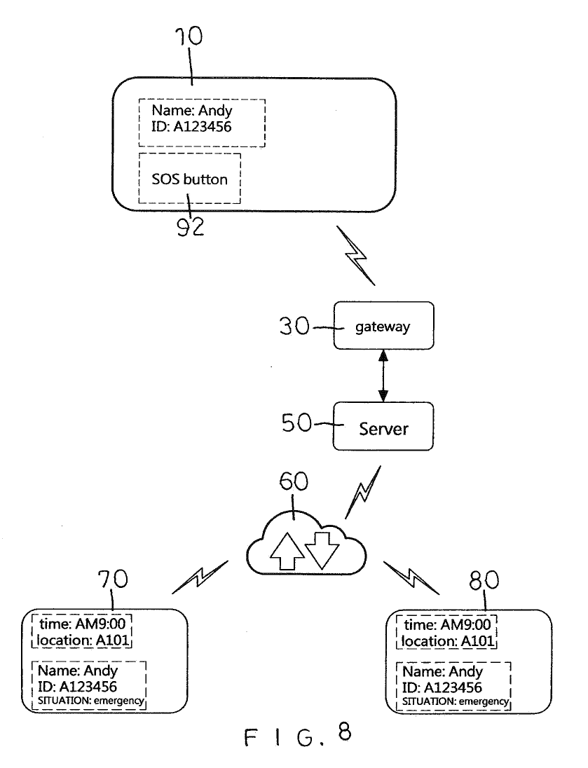

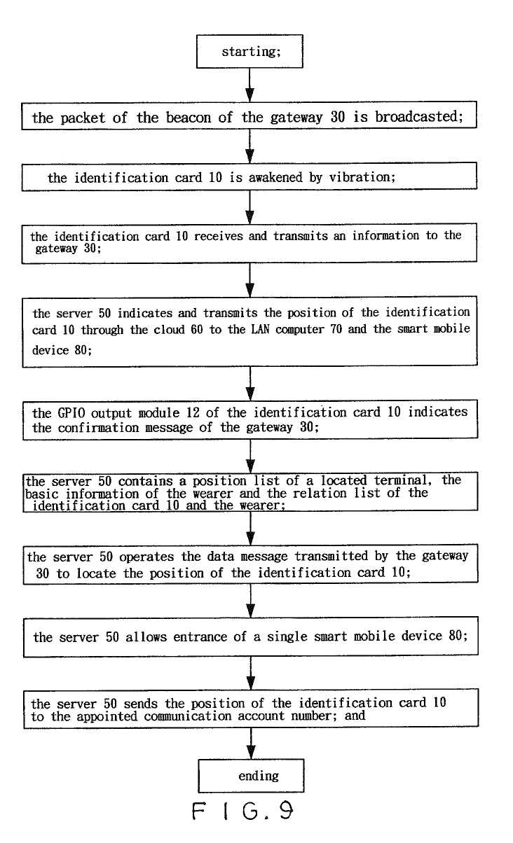

In operation, referring to FIGS. 8 and 9 with reference to FIGS. 1-6, the IPS is performed by the following procedures:

1) starting;

2) the packet of the beacon of the gateway 30 is broadcasted during a constant time interval;

3) the identification card 10 is awakened by vibration to receive and enter the mode of the packet of the beacon of the gateway 30;

4) the identification card 10 and the gateway 30 have a two-direction transmission, so that the identification card 10 receives the information (concerning the packet of the beacon, the signal strength of the gateway 30 and the like) from the gateway 30 and transmits an information (concerning the power rate, activation of the SOS button 92 and the like) to the gateway 30;

5) the server 50 receives the information (the beacon and the signal strength of the gateway 30) from the gateway 30, cooperates with a prebuilt environmental model, to calculate and indicate the position of the identification card 10, and transmits the position and state of the identification card 10 to the cloud 60, and through the cloud 60 to the LAN computer 70 and the smart mobile device 80;

6) the GPIO output module 12 of the identification card 10 indicates the confirmation message transmitted by the gateway 30;

7) the server 50 at least contains a position list of a located terminal (that is produced by the environmental model), the basic information of the wearer and the relation list of the identification card 10 and the wearer, and a management terminal of the server 50 instantaneously receives the data message transmitted by the gateway 30;

8) the server 50 operates the data message transmitted by the gateway 30 to locate the position of the identification card 10;

9) the server 50 allows entrance of a single smart mobile device 80 and presets a selected condition to inquire the position of the identification card 10 after entrance of the smart mobile device 80;

10) the server 50 allows the management staff to preset a list of communication account numbers and sends the position of the identification card 10 to the appointed communication account number according to the selected condition; and

11) ending.

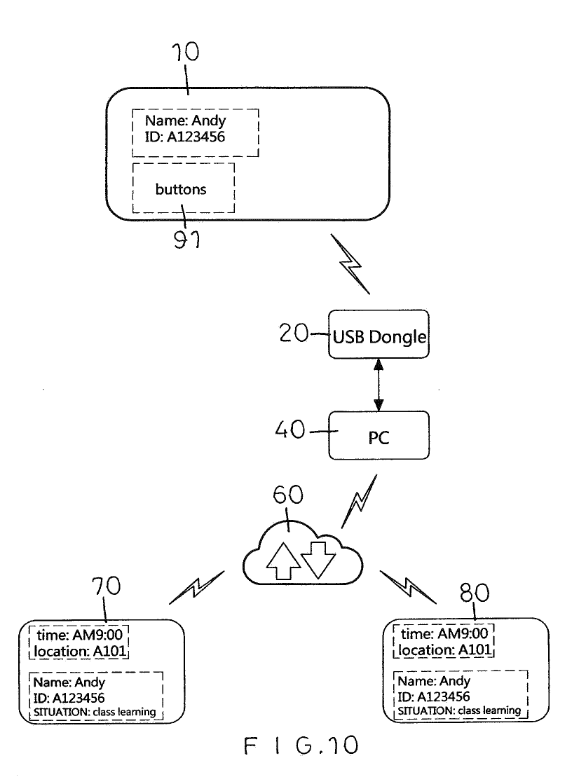

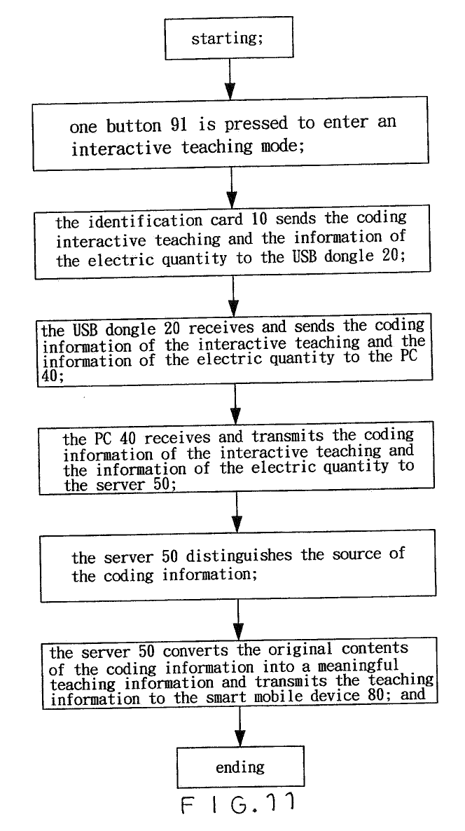

Alternatively, referring to FIGS. 10 and 11 with reference to FIGS. 1-6, the IRS is performed by the following procedures:

1) starting;

2) one of the buttons 91 of the identification card 10 is pressed to enter an interactive teaching mode which activates a coding information of an interactive teaching and an information of an electric quantity;

3) the identification card 10 sends the coding information of the interactive teaching and the information of the electric quantity to the USB dongle 20;

4) the USB dongle 20 receives and sends the coding information of the interactive teaching and the information of the electric quantity to the PC 40 by a serial port;

5) the PC 40 receives and transmits the coding information of the interactive teaching and the information of the electric quantity to the server 50;

6) the server 50 at least contains the basic information of the wearer and the relation list of the identification card 10 and the wearer, to distinguish the source of the coding information of the interactive teaching;

7) the server 50 converts the original contents of the coding information of the interactive teaching into a meaningful teaching information and transmits the teaching information to the smart mobile device 80; and

8) ending.

Accordingly, the IPS has the following functions.

1. Usage and management of school equipment: the school can use the digitalized information management system, to manage the equipment efficiently, and to inquire the operation condition of the equipment rapidly according to the information of the borrow records.

2. Student book lending management: the primary school library is digitalized by use of the RFID or NFC, so that the books are lent and borrowed automatically, without needing the current paper registration procedures, and the students can directly uses the digital student card book borrowing system and services, to borrow the books quickly. The school uses the digitalized library system to manage the books efficiently, and can inquire the book use status and analyze the student reading modes according to the book borrow information.

3. Notification service of school attendance: the system will inform the instructor of the class when the student is absent or has abnormal behaviors, and the instructor will confirm the condition immediately and transmits a message to notify the parents to shorten the crisis processing time.

4. Management service of student body temperature abnormality: when the body temperature of the student is abnormal and exceeds the standard value, the teacher can immediately handle and notify the parents.

5. Management service of danger region warning: the system warns and prevents the school children from entering danger regions.

6. Campus student cleaning area security management: when the student at the school cleaning area encounters danger and asks for help, the system shows the location of the warning area and emits warning sound to remind the relevant personnel to have an emergency treatment. The system also has with the function: the cleaning area overdue back to school information and historical information query.

7. Notification function of emergency call: when the student is in danger and pushes the SOS button 92, the system, judges the location of the student and informs the relevant personnel to have an emergency treatment, thereby shortening the rescue time.

In addition, the IRS for the teachers has the following functions.

1. The teachers and the students have two-way interaction, to enhance the class management, to improve the class order and efficiency, and to control the progress.

2. The IRS is the best assistant tools for classroom teaching, such as PPT multimedia editing materials, multi-interactive mode, quizzes, report statistics and the like.

3. The IRS has a cloud storage platform, for example, course materials, student achievement, learning diagnosis, class without burden and the like.

4. The IRS has a bonus point exchange mechanism.

In addition, the IPS for the teachers has the following functions.

1. The IPS has a school access control management and name call-over mechanism.

2. The IPS has the Line software of the smart mobile device 80 and the SOS emergency help notification and can optimize the efficiency of crisis management (school security incident).

3. The NFC or RFID technology is a usual technology for the library borrowing, the administrative management (such as photocopying, restaurant, access control, equipment borrowing and the like) and the personnel management.

In addition, the IRS for the students has the following functions.

1. The students feed back to the teachers synchronously, so that the students are willing to learn actively.

2. The IRS provides an E-education function (by game playing teaching) to increase the learning interest of the students, so that the students are willing to express their opinions, thereby enhancing the learning effect.

In addition, the IPS for the students has the following functions.

1. The IPS has a name call-over mechanism.

2. The IPS provides the SOS emergency help notification function to have an anti-bullying effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1: A smart identification card structure comprising:
an identification card including an IPS (indoor presence system) and an IRS (interactive response system);
wherein:
the identification card is provided with a GPIO input module, a GPIO output module, and a communication module;
the IPS is provided at a first face of the identification card;
the IRS is provided at a second face of the identification card;
the IPS is connected to a gateway which is connected to a server which is connected to a cloud which is connected to a LAN (local area network) computer and a smart mobile device;
the communication module of the identification card is selectively connected to a wireless network receiver of the gateway;
the IRS is connected to a USB dongle which is connected to a PC (personal computer) which is connected to the cloud;
the communication module of the identification card is selectively connected to the USB dongle; and
the IRS is provided with a plurality of buttons which are connected to a software of the IRS.

2: The smart identification card structure of claim 1, wherein the communication module of the identification card is detected automatically to the cloud by a bluetooth or RF or RFID (radio frequency identification) or NFC (near field communication).

3: The smart identification card structure of claim 1, wherein the first face of the identification card is provided with a SIC (student identity card) which contains a basic information of a student, including a photograph, name, class and ID (identification) number.

4: The smart identification card structure of claim 1, wherein the second face of the identification card is provided with an SOS button.

5: The smart identification card structure of claim 1, wherein the second face of the identification card is provided with a wireless communication indication light which has a green color.

6: The smart identification card structure of claim 1, wherein the second face of the identification card is provided with a battery and a low voltage warning light, and the low voltage warning light has a red color.

7: The smart identification card structure of claim 1, wherein the second face of the identification card is provided with a vibration detector which detects the identification card and notifies a user when the identification card is motionless to a preset time.

8: The smart identification card structure of claim 1, wherein the second face of the identification card is provided with a buzzer.

9: The smart identification card structure of claim 1, wherein the identification card is provided with a stored value facility.

10: The smart identification card structure of claim 1, wherein the identification card uses the App of a cell phone.

11: The smart identification card structure of claim 1, wherein the smart mobile device is a smart cell phone.

12: The smart identification card structure of claim 1, wherein the identification card is provided with an upright hanging hole and a transverse hanging hole.
